(19) United States
(12) Patent Application Publication
(10) Pub. No.: US 2016/0135441 A1
(43) Pub. Date: May 19, 2016

(54) FISHING POLE WITH LEVERAGE BAR

(71) Applicants: Peter Russo, Matawan, NJ (US); Teresa Russo, Matawan, NJ (US)

(72) Inventors: Peter Russo, Matawan, NJ (US); Teresa Russo, Matawan, NJ (US)

(21) Appl. No.: 14/546,072

(22) Filed: Nov. 18, 2014

(51) Int. Cl. A01K 87/08; A01K 99/00; A01K 87/02

(52) U.S. Cl. CPC A01K 87/08; A01K 87/02; A01K 99/00

(57) ABSTRACT

A fishing pole with leverage bar comprising a fishing pole, where the fishing pole includes a rod and a handle; a leverage bar attached to the handle, where the leverage bar is positioned parallel to the handle; a pair of fasteners to attach the leverage bar to the handle, where the pair of fasteners enable movement of the leverage bar from an extended position to a retracted position. The fishing pole with leverage bar provides a convenient armrest upon which a fisherman rests their arm while retrieving in a fish.

### BACKGROUND OF THE INVENTION

1. Field of the Invention

The present invention relates to a rest on a fishing pole to provide leverage when retrieving in a large catch.

2. Description of Related Art

Many people enjoy fishing as a fun recreational activity or as a competitive sporting event. As their skills develop, most fishermen have their preferred techniques from types of lure, weight of the rod, and style for casting. Never the less a few concepts are common; utilizing a hook and a line to snare a fish. Even though the basic concept is simple, the techniques used have transformed fishing into what some consider an art form, with a preferred style for everyone. Also, the type, size and weight of the fish sought can determine the length, weight, flexibility, and speed of the rod.

Even during a relaxing trip, fishing is an activity that requires upper body strength to cast and retrieve the lure. Many times the fisherman must continuously support and brace their pole until they reel in the line. For assistance, some people dig a small hole and burry a portion of the handle into the ground to hold the pole upright. Alternatively, pole holders are available to provide a resting spot upon which the fisherman may lay their pole. While these methods and devices are helpful to rest the arms while waiting for a fish, they are not supportive when actually retrieving the catch. Often with a large fish, the struggle is difficult and tiring as the fish fights to get away. The fisherman's body is strained and fatigued as they pull and adjust for better leverage which may cause injury or losing the fish if the wrong move is made.

Therefore it would be beneficial in the art to provide a device to support a fisherman's body as they retrieve a difficult catch. It would also be desirable in the art to provide a fishing pole support that does not interfere with casting, maintaining a compact configuration when not in use.

### SUMMARY OF THE INVENTION

In view of the foregoing disadvantages inherent in the prior art, the general purpose of the present invention is to provide a fishing pole with leverage bar to provide an armrest for a fisherman, configured to include all of the advantages of the prior art, and to overcome the drawbacks inherent therein.

Accordingly, an object of the present invention is to provide a fishing pole with leverage bar as a support against the fisherman's forearm when retrieving a fish.

Another object of the present invention is to provide a fishing pole with leverage bar where the leverage bar moves between an extended position and a retracted position.

To achieve the above objects, in an aspect of the present invention, a fishing pole with leverage bar is described comprising a fishing pole, where the fishing pole includes a rod and a handle; a leverage bar attached to the handle, where the leverage bar is positioned parallel to the handle; a pair of fasteners to attach the leverage bar to the handle, where the pair of fasteners enable movement of the leverage bar from an extended position to a retracted position.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings in which:

FIG. 1 depicts a side view of a fishing pole with leverage bar in accordance with an exemplary embodiment of the present invention; and

FIG. 2 depicts a perspective view of a leverage bar in accordance with an exemplary embodiment of the present invention.

Like reference numerals refer to like parts throughout the description of several views of the drawings.

### DETAILED DESCRIPTION OF THE DRAWINGS

The present invention relates to a rest on a fishing pole to provide leverage when retrieving in a large catch. The present invention provides a fishing pole with leverage bar to facilitate the process of catching fish. The fishing pole includes a leverage bar attached to the handle portion of the pole. The leverage bar receives a fisherman's forearm to support the arm while pulling and reeling in a fish. The leverage bar may attach to the handle with a spring loaded mechanism that allows movement between an extended position and a retracted position against the handle. The fishing pole with leverage bar creates a convenient place to rest an arm while also reducing hand and arm strain while fishing.

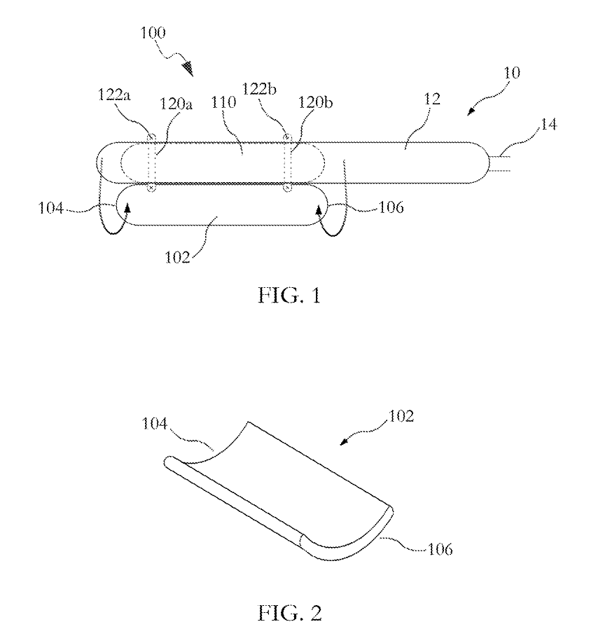

Turning now descriptively to the drawing, FIG. 1 shows a fishing pole with leverage bar 100 in accordance with an exemplary embodiment of the present invention. The fishing pole with leverage bar 100 includes a fishing pole 10 extending between a handle 12 and a rod 14. A leverage bar 102 is mounted on the handle 12, and extends between a first end 104 and a second end 106. The leverage bar 102 may be a padded armrest for the handle 12 that provides additional leverage to the handle 12 when reeling in a large or difficult fish. During use, the user may position their forearm and/or elbow into the leverage bar 102 to help bear down on the pole 10 when additional leverage and strength is needed. This way greater body leverage is pressed into the handle 12 thereby creating less strain on the fisherman's hands, arms and upper body.

The leverage bar 102 moves between an extended position 102 and a retracted position 110. The leverage bar 102 may flip between the extended position 102 and the retracted position 110 with a pair of fasteners 120 that hold each end 104, 106. When in the leverage bar 102 is extended it remains parallel to the handle 12 so that the fisherman may easily rest their forearm. When the leverage bar 110 is retracted it rests flush against the handle 12 to remain out of the way for casting and storage. The fasteners 120 may be spring loaded so that when detached from their locks 122 they automatically extend the leverage bar 102. During casting, the user may keep the leverage bar in the retracted position 110, until needed to retrieve the fish, at which point the fasteners 120 are released to move the leverage bar into the extended position 102.

Referring now to FIG. 2, a perspective view of the leverage bar 102 is shown in accordance with an exemplary embodiment of the present invention. The leverage bar 102 is curved along the ends 104, 106 to concave the leverage bar 102. Thus a curve runs along the length of the leverage bar 102. With a concave leverage bar 102 the user's forearm is comfortably hugged as it rests and presses against the surface of the bar 102. Additionally, the concave leverage bar 102 easily wraps around the fishing pole handle when in the retracted position. The ends 104, 106 are curved for comfort against the arm. The leverage bar 102 may range from 6-10 inches in length and 2-8 inches in width; preferably measuring 7 inches by 2 inches. Additionally, the leverage bar 102 including the first end 104 and the second end 106 may be padded with a rubber, foam, leather or other material for comfort and durability. The leverage bar 102 may be made from aluminum, plastic, wood or the like and covered with a soft, waterproof material. All materials must be able to withstand all weather conditions encountered while fishing. With the fishing pole with leverage bar the user receives the additional strength required when reeling in a large catch. Strain and pain is reduced by not having to manhandle the fish alone.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A fishing pole with leverage bar comprising:
a. a fishing pole, where the fishing pole includes a rod and a handle;
b. a leverage bar attached to the handle, where the leverage bar extends between a first end and a second end;
c. a pair of fasteners to attach the leverage bar to the handle, where the pair of fasteners enable movement of the leverage bar from an extended position to a retracted position.

2. The fishing pole with leverage bar according to claim 1, where the leverage bar is positioned parallel to the handle.

3. The fishing pole with leverage bar according to claim 1, where the leverage bar is concave, where the first end and the second end are curved.

4. The fishing pole with leverage bar according to claim 1, where the leverage bar is padded.

5. The fishing pole with leverage bar according to claim 1, where the pair of fasteners is spring loaded to move the leverage bar from the retracted position into the extended position.

6. The fishing pole with leverage bar according to claim 1, where the pair of fasteners each include a lock, where the locks maintain the leverage bar in the retracted position.
